(19) United States
(12) Patent Application Publication
(10) Pub. No.: US 2024/0329919 A1
(43) Pub. Date: Oct. 3, 2024

(54) SPEECH MESSAGE PLAYBACK

(71) Applicant: Tencent Technology (Shenzhen) Company Limited, Shenzhen (CN)

(72) Inventors: Teng CHEN, Shenzhen (CN); Zhihong LIN, Shenzhen (CN)

(73) Assignee: Tencent Technology (Shenzhen) Company Limited, Shenzhen (CN)

(21) Appl. No.: 18/739,075

(22) Filed: Jun. 10, 2024

Related U.S. Application Data
(63) Continuation of application No. PCT/CN2023/090009, filed on Apr. 23, 2023.

(30) Foreign Application Priority Data
Jun. 23, 2022 (CN) 202210726517.3

(51) Int. Cl. G06F 3/16; G06F 3/0481; G10L 13/02; G10L 13/08

(52) U.S. Cl. CPC G06F 3/165; G06F 3/0481; G10L 13/02; G10L 13/08

(57) ABSTRACT

A method of speech message playback includes displaying a virtual social scenario including a first virtual figure associated with a first social account. The first social account of the first virtual figure performs social interaction with at least another social account in the virtual social scenario. The method includes displaying, when one or more social messages transmitted by a second social account are received and the one or more social messages include a speech message, a speech message playback control at a message prompt position of a second virtual figure associated with the second social account in the virtual social scenario. The method also includes playing back, in response to a first trigger operation on the speech message playback control, the speech message in the virtual social scenario without involving a message processing interface listing the one or more social messages received from the second social account.

### RELATED APPLICATIONS

The present application is a continuation of International Application No. PCT/CN2023/090009, entitled “METHOD AND APPARATUS FOR PLAYING SPEECH MESSAGE, AND TERMINAL AND STORAGE MEDIUM” and filed on Apr. 23, 2024, which claims priority to Chinese Patent Application No. 202210726517.3, entitled “SPEECH MESSAGE PLAYBACK METHOD AND APPARATUS, TERMINAL, AND STORAGE MEDIUM” and filed on Jun. 23, 2022. The entire disclosures of the prior applications are hereby incorporated by reference.

### FIELD OF THE TECHNOLOGY

Embodiments of this application relate to the field of human-computer interaction technologies, including techniques for a speech message playback.

### BACKGROUND OF THE DISCLOSURE

During social interaction by using a social platform, a social message often includes a large quantity of speech messages in addition to text and picture messages.

In the related art, when the social message is received, an unread message prompt is displayed in a message list interface. An unread message can be processed, for example, by viewing a text message and a picture message, or playing back a speech message, on a message processing interface by clicking/tapping the unread message prompt.

However, in the foregoing method, it is needed to enter the message processing interface to learn a specific type of the unread message. For a social message with a strong interactive attribute such as the speech message, an operation of obtaining the social message is cumbersome and less convenient.

### SUMMARY

Embodiments of this disclosure provide a speech message playback method and apparatus, a terminal, and a storage medium, to improve convenience of a speech message playback operation. The technical solutions are as follows.

According some aspects of the disclosure, a method of speech message playback includes displaying a virtual social scenario including a first virtual figure associated with a first social account. The first social account of the first virtual figure performs social interaction with at least another social account in the virtual social scenario. The method includes displaying, when one or more social messages transmitted by a second social account are received and the one or more social messages include a speech message, a speech message playback control at a message prompt position of a second virtual figure associated with the second social account in the virtual social scenario. The method also includes playing back, in response to a first trigger operation on the speech message playback control, the speech message in the virtual social scenario without involving a message processing interface listing the one or more social messages received from the second social account.

According to another aspect, an embodiment of this disclosure provides a speech message playback apparatus. The apparatus includes processing circuitry configured to display a virtual social scenario including a first virtual figure associated with a first social account. The first social account of the first virtual figure performs social interaction with at least another social account in the virtual social scenario. The processing circuitry is further configured to display, when one or more social messages transmitted by a second social account is received and the one or more social messages includes a speech message, a speech message playback control at a message prompt position of a second virtual figure associated with the second social account in the virtual social scenario. The processing circuitry is also configured to play back, in response to a first trigger operation on the speech message playback control, the speech message in the virtual social scenario without involving a message processing interface listing the one or more social messages received from the second social account.

According to another aspect, an embodiment of this disclosure provides a terminal. The terminal includes a processor (also referred to as processing circuitry in some examples) and a memory. The memory has at least one instruction stored therein, and the at least one instruction is executed by the processor to implement the speech message playback method according to the foregoing aspect.

According to another aspect, an embodiment of this disclosure provides a non-transitory computer-readable storage medium. The non-transitory computer-readable storage medium has at least one program code stored thereon, and the program code is loaded and executed by a processor to implement the speech message playback method according to the foregoing aspect.

According to another aspect, an embodiment of this disclosure provides a computer program product. The computer program product includes computer instructions stored in a computer-readable storage medium. A processor of a computer device reads the computer instructions from the computer-readable storage medium. The processor executes the computer instructions to cause the computer device to perform the speech message playback method provided in various implementations of the foregoing aspect.

According to embodiments of this disclosure, a virtual social scenario for social interaction of a virtual figure corresponding to at least one social account is constructed. In the virtual social scenario, when a social message including a speech message transmitted by a target social account is received, a speech message playback control is displayed at a message prompt position corresponding to a target virtual figure for a user to trigger. In this way, the speech message is played back in the virtual social scenario without displaying a message processing interface corresponding to the target social account. By using the solution provided in embodiments of this disclosure, in the virtual social scenario, the speech message transmitted by the target social account can be prompted notably. In addition, the speech message playback control is provided for a user to trigger, to quickly play back the speech message in the virtual social scenario. In this way, a process of switching to display the message processing interface corresponding to the target social account is omitted, a process of a speech message playback operation is simplified, and convenience of the speech message playback operation is improved.

### BRIEF DESCRIPTION OF THE DRAWINGS

FIG. 1 is a schematic diagram of an implementation environment according to an embodiment of this disclosure.

FIG. 2 is a flowchart of a speech message playback method according to an exemplary embodiment of this disclosure.

FIG. 3 is a schematic diagram of an interface of a virtual social scenario according to an exemplary embodiment of this disclosure.

FIG. 4 is a schematic diagram of an interface of a speech message playback operation according to an exemplary embodiment of this disclosure.

FIG. 5 is a schematic diagram of an interface of displaying a speech message playback control and a first message prompt control according to an exemplary embodiment of this disclosure.

FIG. 6 is a schematic diagram of another interface of displaying a speech message playback control and a first message prompt control according to an exemplary embodiment of this disclosure.

FIG. 7 is a schematic diagram of an interface of displaying a speech message playback control and a second message prompt control according to an exemplary embodiment of this disclosure.

FIG. 8 is a schematic diagram of an interface of separately displaying a speech message playback control according to an exemplary embodiment of this disclosure.

FIG. 9 is a schematic diagram of an interface of separately displaying a second message prompt control according to an exemplary embodiment of this disclosure.

FIG. 10 is a schematic diagram of control display when different quantities of speech messages and non-speech messages are received according to an exemplary embodiment of this disclosure.

FIG. 11 is a schematic diagram of an interface of updating a speech message playback control to a second message prompt control according to an exemplary embodiment of this disclosure.

FIG. 12 is a schematic diagram of an implementation of control switching when different quantities of speech messages and non-speech messages are received according to an exemplary embodiment of this disclosure.

FIG. 13 is a schematic diagram of an interface of displaying a message processing interface according to an exemplary embodiment of this disclosure.

FIG. 14 is a schematic diagram of an interface of switching between a pause button and a playback button according to an exemplary embodiment of this disclosure.

FIG. 15 is a flowchart of a speech message playback method according to another exemplary embodiment of this disclosure.

FIG. 16 is an interaction sequence diagram between a user layer, a presentation layer, and a background logic layer according to an exemplary embodiment of this disclosure.

FIG. 17 is a block diagram of a structure of a speech message playback apparatus according to an exemplary embodiment of this disclosure.

FIG. 18 is a schematic diagram of a structure of a terminal according to an exemplary embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

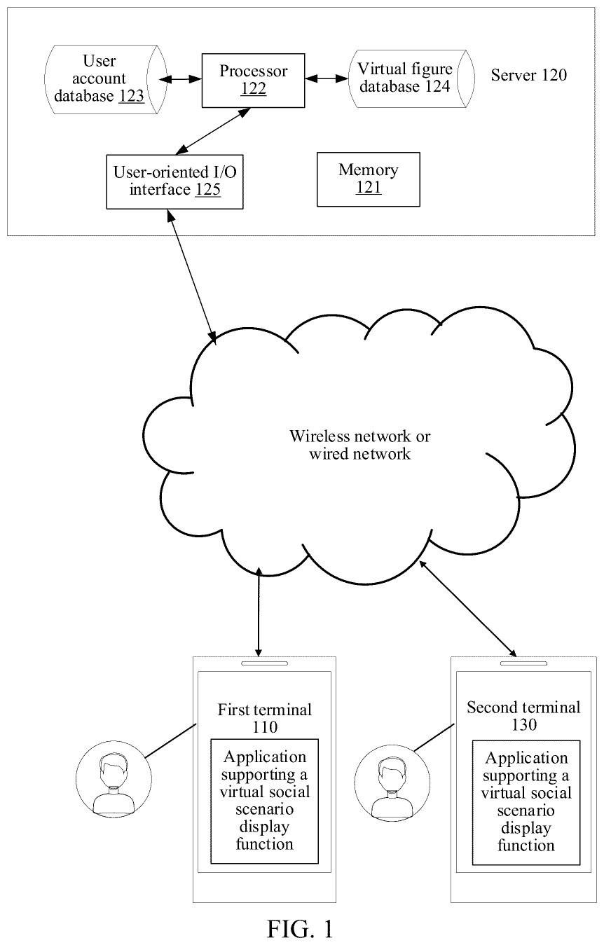

FIG. 1 is a schematic diagram of an implementation environment according to an embodiment of this disclosure. The implementation environment may include a first terminal 110, a server 120, and a second terminal 130.

The first terminal 110 and the second terminal 130 are electronic devices having a virtual social scenario display function. The virtual social scenario display function may be implemented by one functional module in an application with a social attribute, or may be implemented by an independent desktop client or web client. For example, the virtual social scenario display function is implemented as one functional module in an instant messaging application, which is configured for a registered user to perform social interaction in a virtual social scenario by using a virtual figure. The electronic device may be a smartphone, a tablet computer, a personal computer, a wearable device, an on board terminal, or the like.

In one embodiment, applications installed on the first terminal 110 and the second terminal 130 are the same, or applications installed on the two terminals are the same type of applications on different operating system platforms (Android or IOS). The first terminal 110 may generally refer to one of a plurality of terminals, and the second terminal 130 may generally refer to another one of the plurality of terminals. This embodiment only uses the first terminal 110 and the second terminal 130 as an example. Device types of the first terminal 110 and the second terminal 130 are the same or different. The device type includes at least one of a smartphone, a tablet computer, an e-book reader, an MP3 player, an MP4 player, a portable laptop computer, or a desktop computer.

In FIG. 1, an example in which the first terminal 110 and the second terminal 130 are smartphones, and applications having the virtual social scenario display function are installed is used for description, and does not constitute a limitation to this application.

Only two terminals are shown in FIG. 1, but there are a plurality of other terminals that may access the server 120 in different embodiments. The first terminal 110, the second terminal 130, and the other terminals are connected to the server 120 over a wireless network or a wired network.

The server 120 includes at least one of a server, a server cluster including a plurality of servers, a cloud computing platform, or a virtualization center. The server 120 is configured to provide a background service for an application supporting the virtual social scenario. In one embodiment, the server 120 undertakes main computing work and the terminal undertakes secondary computing work; or the server 120 undertakes secondary computing work and the terminal undertakes main computing work; or a distributed computing architecture is used between the server 120 and the terminal for collaborative computing.

The server 120 may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

For example, the server 120 includes a memory 121, a processor 122, a user account database 123, a virtual figure database 124, and a user-oriented input/output interface (I/O interface) 125. The processor 122 is configured to load instructions stored in the server 120 and process the user account database 123 and the virtual figure database 124. The user account database 123 is configured for storing data of user accounts used by the first terminal 110, the second terminal 130, and the other terminals, such as avatars of the user accounts and nicknames of the user accounts. The virtual figure database 124 is configured for storing figure data of virtual figures created by various user accounts. The user-oriented I/O interface 125 is configured to establish communication between the first terminal 110 and/or the second terminal 130 over a wireless network or a wired network to exchange data, to implement receiving and transmitting of social messages between accounts.

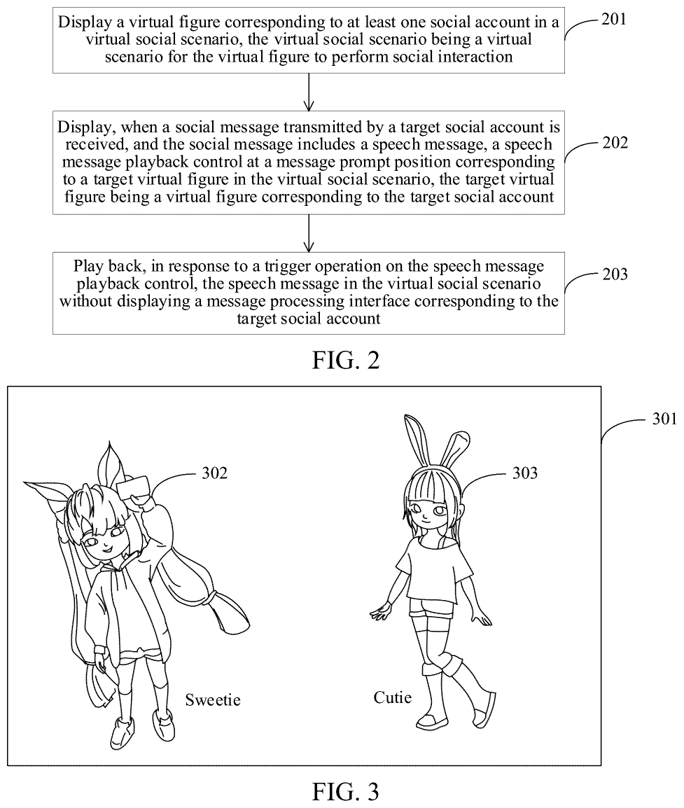

FIG. 2 is a flowchart of a speech message playback method according to an exemplary embodiment of this disclosure. In this embodiment, an example in which the method is applied to the terminal shown in FIG. 1 is used for description. The method may include the following operations:

Operation 201: Display a virtual figure corresponding to at least one social account in a virtual social scenario, the virtual social scenario being a virtual scenario for the virtual figure to perform social interaction.

Different from a social account list display interface in the related art, in this embodiment of this disclosure, the virtual social scenario includes virtual figures corresponding to different social accounts, and these virtual figures represent social accounts to perform social interaction.

In one embodiment, a virtual figure corresponding to a social account that establishes a social relationship with the social account may be displayed in the virtual social scenario, or a virtual figure corresponding to another social account that does not establish a social relationship with the social account may be displayed. This is not limited in this embodiment of this disclosure.

In one embodiment, the virtual social scenario may be customized by a user. To be specific, virtual social scenarios displayed by logging into different social accounts may be the same or different. For example, a social account “John” sets the virtual social scenario as a virtual park, and a social account “Louis” sets the virtual social scenario as a virtual restaurant.

In one embodiment, the virtual social scenario includes a setting interface for creating the virtual figure. By designing and dressing up the virtual figure, virtual figures corresponding to different social accounts may be the same or different. In addition, to easily distinguish the virtual figures corresponding to various social accounts, a unique label that can represent the virtual figure is displayed around the virtual figure in the virtual social scenario. The label may be an account name of the social account or another label that can distinguish the virtual figure from other virtual figures.

For example, as shown in FIG. 3, the terminal displays a first virtual FIG. 302 corresponding to a first social account and a second virtual FIG. 303 corresponding to a second social account in a virtual social scenario 301. To easily distinguish the virtual figures corresponding to different social accounts, an account name of the first social account is displayed around the first virtual FIG. 302, and an account name of the second social account is displayed around the second virtual FIG. 303.

Operation 202: Display, when a social message transmitted by a target social account is received, and the social message includes a speech message, a speech message playback control at a message prompt position corresponding to a target virtual figure in the virtual social scenario, the target virtual figure being a virtual figure corresponding to the target social account.

In one embodiment, a social message transmitted between social accounts may include a text message, a picture message, a video message, a website link, a speech message, and the like.

In some embodiments, the virtual figure has a corresponding message prompt position. When the social account receives a social message, a prompt for receiving the social message is displayed at a message prompt position of a virtual figure corresponding to an account transmitting the social message, so that the social interaction can be performed directly by the virtual figure.

In an implementation example, a current account receives the social message transmitted by the target social account among the at least one social account. The target social account is set with a corresponding target virtual figure, and the social message includes a speech message, so that the terminal displays the speech message playback control at the message prompt position corresponding to the target virtual figure in the virtual social scenario.

In one embodiment, the received social message may include only a speech message, only a non-speech message, or both a speech message and a non-speech message.

In one embodiment, the message prompt position may be a head position of the target virtual figure, or a left position of the target virtual figure, or another position that can represent a correspondence between the speech message playback control and the target virtual figure. This is not limited in this embodiment of this disclosure.

In one embodiment, received speech duration, a quantity of the received speech messages, a speech message playback button, and the like may be displayed in the speech message playback control. When the speech duration is displayed, a length of the speech message playback control may be adjusted according to the speech duration. When a speech message is received, the speech message playback control may be set with a jitter prompt function to remind the current account to receive the speech message, to quickly reply to the speech message.

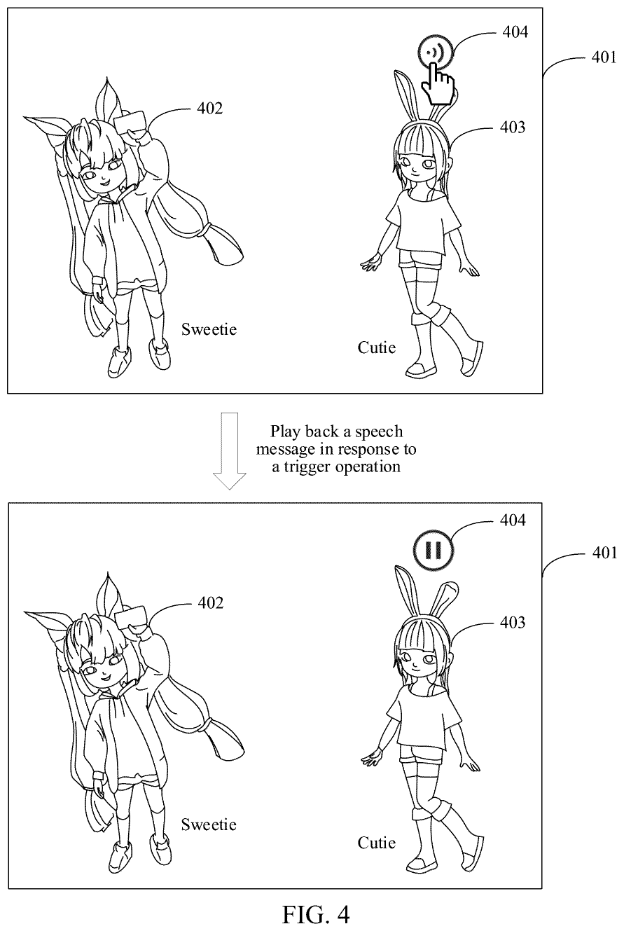

For example, as shown in FIG. 4, in a virtual social scenario 401 corresponding to the current account, a current account corresponds to a virtual FIG. 402, and a target social account corresponds to a target virtual FIG. 403. When the social message transmitted by the target social account is received, and the social message includes a speech message, the terminal displays a speech message playback control 404 at a head position of the target virtual FIG. 403.

Operation 203: Play back, in response to a trigger operation on the speech message playback control, the speech message in the virtual social scenario without displaying a message processing interface corresponding to the target social account.

To simplify operations of a speech message playback operation, the terminal directly plays back, in response to the trigger operation on the speech message playback control in the virtual social scenario, the speech message in the virtual social scenario without switching to display the message processing interface corresponding to the target social account.

The message processing interface includes the received speech message and another non-speech message transmitted by the target social account, and the current account may transmit a social message to the target social account on the message processing interface. The social message may include a text message, a speech message, a picture message, a video message, and the like.

For example, as shown in FIG. 4, the terminal directly plays back, in response to a trigger operation on the speech message playback control 404, the speech message in the virtual social scenario 401 without displaying a message processing interface.

In conclusion, according to embodiments of this disclosure, the virtual social scenario for social interaction of the virtual figure corresponding to the at least one social account is constructed. In the virtual social scenario, when a social message including a speech message transmitted by the target social account is received, the speech message playback control is displayed at the message prompt position corresponding to the target virtual figure for a user to trigger. In this way, the speech message is played back in the virtual social scenario without displaying the message processing interface corresponding to the target social account. By using the solution provided in embodiments of this disclosure, in the virtual social scenario, the speech message transmitted by the target social account can be prompted notably. In addition, the speech message playback control is provided for a user to trigger, to quickly play back the speech message in the virtual social scenario. In this way, a process of switching to display the message processing interface corresponding to the target social account is omitted, a process of a speech message playback operation is simplified, and convenience of the speech message playback operation is improved.

Because the received social message includes not only the speech message, but also a non-speech message, such as a text message, a picture message, and a video message, when the speech message and the non-speech message are received, at the message prompt position corresponding to the target virtual figure in the virtual social scenario, three different methods for displaying a social message are provided in this embodiment of this disclosure. The following respectively describes the three methods for displaying a social message.

1. Display the speech message playback control and a first message prompt control at the message prompt position corresponding to the target virtual figure, where a quantity of unread social messages is displayed in the first message prompt control.

In an implementation example, when the social message transmitted by the target social account is received, and the social message includes a speech message, the terminal displays the speech message playback control and the first message prompt control at the message prompt position corresponding to the target virtual figure in the virtual social scenario.

In an implementation example, a quantity of unread speech messages is not displayed in the speech message playback control, or the quantity of unread speech messages is displayed in the speech message playback control. Because the unread social message includes various types of social messages, the quantity of unread social messages is greater than or equal to the quantity of unread speech messages.

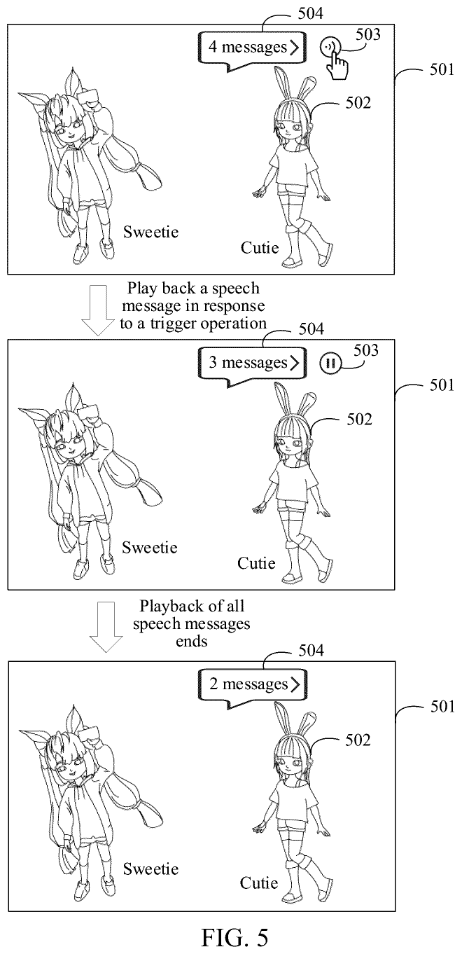

For example, as shown in FIG. 5, when four social messages transmitted by a target social account are received, and the social messages include two speech messages, in a virtual social scenario 501 corresponding to a current account, the terminal displays a speech message playback control 503 and a first message prompt control 504 at a message prompt position corresponding to a target virtual FIG. 502 corresponding to the target social account. A quantity of unread social messages displayed in the first message prompt control 504 is four.

In an implementation example, the terminal plays back, in response to the trigger operation on the speech message playback control, the speech message in the virtual social scenario without displaying the message processing interface corresponding to the target social account. When playback of a current speech message ends, the terminal decreases the quantity of unread social messages displayed in the first message prompt control by one.

For example, as shown in FIG. 5, the terminal starts playing back, in response to a trigger operation on the speech message playback control 503, the speech message in the virtual social scenario 501 without displaying a message processing interface corresponding to the target social account. When playback of the first speech message ends, the terminal decreases the quantity of unread social messages displayed in the first message prompt control 504 by one, so that the quantity of unread social messages displayed in the first message prompt control 504 is three.

In an implementation example, to improve simplicity of screen display in the virtual social scenario, when playback of the current speech message ends, and there is no next unread speech message, the terminal hides the speech message playback control. When all the received social messages are speech messages, the terminal hides the first message prompt control while hiding the speech message playback control.

For example, as shown in FIG. 5, when playback of the last speech message ends, the terminal hides the speech message playback control 503 in the virtual social scenario 501, and decreases the quantity of unread social messages displayed in the first message prompt control 504 by one, so that a quantity of unread non-speech messages displayed in the first message prompt control 504 is two.

In an implementation example, to display the quantity of speech messages included in the unread social messages, the terminal displays the quantity of unread speech messages in the speech message playback control, and plays back the speech message in response to the trigger operation on the speech message playback control. When playback of the current speech message ends, and there is the next speech message, the terminal decreases the quantity of unread speech messages displayed in the speech message playback control by one.

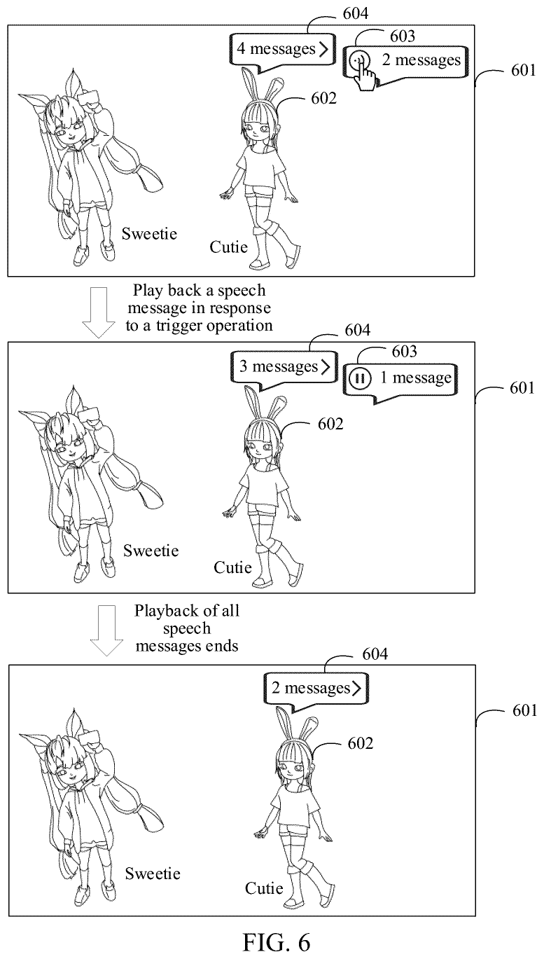

For example, as shown in FIG. 6, when four social messages transmitted by a target social account are received, and the social messages include two speech messages, in a virtual social scenario 601 corresponding to a current account, the terminal displays a speech message playback control 603 and a first message prompt control 604 at a message prompt position corresponding to a target virtual FIG. 602 corresponding to the target social account. A quantity of unread speech messages displayed in the speech message playback control 603 is two, and a quantity of unread social messages displayed in the first message prompt control 604 is four. The terminal starts playing back the speech message in the virtual social scenario 601 in response to a trigger operation on the speech message playback control 603. Because there is the second speech message when playback of the first speech message ends, the terminal decreases the quantity of unread speech messages displayed in the speech message playback control 603 by one, and decreases the quantity of unread social messages displayed in the first message prompt control 604 by one, so that the quantity of unread speech messages displayed in the speech message playback control 603 is one, and the quantity of unread social messages displayed in the first message prompt control 604 is three. When playback of the last speech message, the terminal hides the speech message playback control 603, and decreases the quantity of unread social messages displayed in the first message prompt control 604 by one, so that a quantity of unread non-speech messages displayed in the first message prompt control 604 is two.

2. Display the speech message playback control and a second message prompt control at the message prompt position corresponding to the target virtual figure, where a quantity of unread speech messages is displayed in the speech message playback control, and a quantity of unread non-speech messages is displayed in the second message prompt control.

In an implementation example, to enable the user to intuitively learn respective quantities of speech messages and non-speech messages in social messages, when the social message transmitted by the target social account is received, and the social message includes a speech message, the terminal displays the speech message playback control and the second message prompt control at the message prompt position corresponding to the target virtual figure in the virtual social scenario.

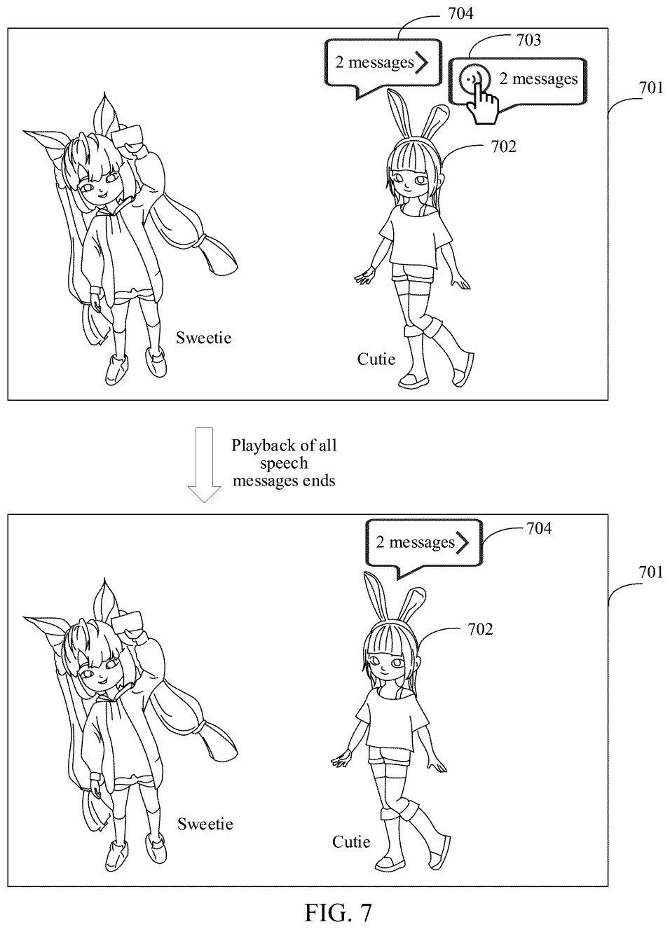

For example, as shown in FIG. 7, when four social messages transmitted by a target social account are received, and the social messages include two speech messages and two non-speech messages, in a virtual social scenario 701 corresponding to a current account, the terminal displays a speech message playback control 703 and a second message prompt control 704 at a message prompt position corresponding to a target virtual FIG. 702 corresponding to the target social account. A quantity of unread speech messages displayed in the speech message playback control 703 is two, and a quantity of unread non-speech messages displayed in the second message prompt control 704 is two.

In an implementation example, the terminal plays back, in response to the trigger operation on the speech message playback control, the speech message in the virtual social scenario without displaying the message processing interface corresponding to the target social account. When playback of the current speech message ends, and there is no next unread speech message, the terminal hides the speech message playback control.

For example, as shown in FIG. 7, the terminal plays back, in response to a trigger operation on the speech message playback control 703, the speech message in the virtual social scenario 701 without displaying a message processing interface corresponding to the target social account. When playback of the last speech message ends, the terminal hides the speech message playback control 703 in the virtual social scenario 701 and only displays the second message prompt control 704.

In an implementation example, when the social message transmitted by the target social account is received, and there is only a speech message in the social message, the terminal only displays the speech message playback control at the message prompt position corresponding to the target virtual figure.

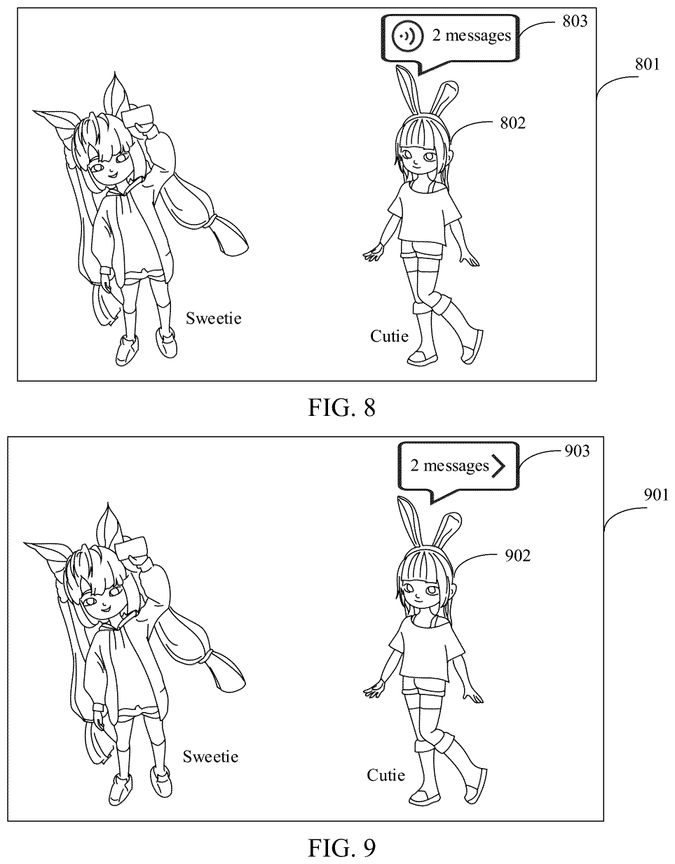

For example, as shown in FIG. 8, when a received social message transmitted by a target social account only includes a speech message, the terminal only displays a speech message playback control 803 at a message prompt position corresponding to a target virtual FIG. 802 in a virtual social scenario 801.

In an implementation example, when the social message transmitted by the target social account is received, and there is only a non-speech message in the social message, the terminal directly displays the second message prompt control at the message prompt position corresponding to the target virtual figure.

For example, as shown in FIG. 9, when a received social message transmitted by a target social account only includes a non-speech message, the terminal directly displays a second message prompt control 903 at a message prompt position corresponding to a target virtual FIG. 902 in a virtual social scenario 901.

Because the speech message playback control and the second message prompt control are respectively configured for indicating quantities of unread social messages with different types, during a process of playing back the speech message by triggering the speech message playback control, the quantity of unread speech messages displayed in the speech message playback control decreases, while the quantity of unread non-speech messages displayed in the second message prompt control remains unchanged.

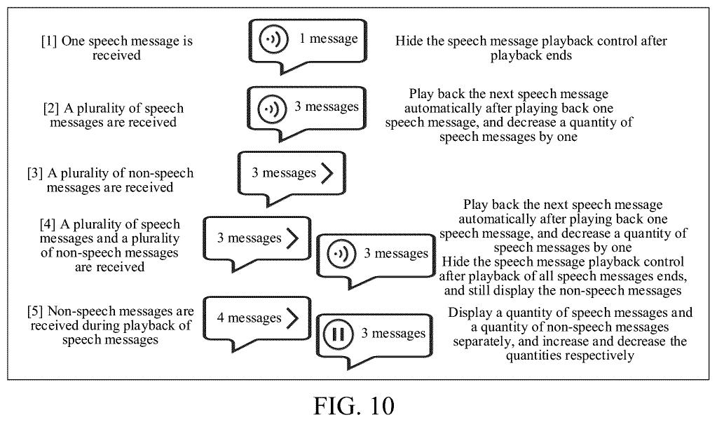

FIG. 10 is a schematic diagram of control display when different quantities of speech messages and non-speech messages are received according to an exemplary embodiment of this disclosure.

When receiving one speech message, the terminal displays the speech message playback control in the virtual social scenario. A quantity of unread speech messages displayed in the speech message playback control is one. The terminal plays back the speech message in response to the trigger operation on the speech message playback control. When playback of the speech message ends, the terminal hides the speech message playback control.

When receiving three speech messages, the terminal displays the speech message playback control in the virtual social scenario. A quantity of unread speech messages displayed in the speech message playback control is three. The terminal plays back the speech messages in response to the trigger operation on the speech message playback control. After playing back one speech message, the terminal automatically plays back the next speech message and decreases the quantity of unread speech messages displayed in the speech message playback control by one.

When receiving a plurality of non-speech messages, the terminal displays the second message prompt control in the virtual social scenario, and the quantity of unread non-speech messages is displayed in the second message prompt control.

When receiving a plurality of non-speech messages and a plurality of speech messages, the terminal simultaneously displays the speech message playback control and the second message prompt control in the virtual social scenario. The quantity of unread speech messages is displayed in the speech message playback control, and the quantity of unread non-speech messages is displayed in the second message prompt control. The terminal plays back the speech messages in response to the trigger operation on the speech message playback control. After playing back one speech message, the terminal automatically plays back the next speech message and decreases the displayed quantity of unread speech messages by one. After playing back all the speech messages, the terminal hides the speech message playback control, and the second message prompt control remains unchanged.

During the playback of the speech message, when receiving one non-speech message, the terminal increases one to the quantity of unread non-speech messages displayed in the second message prompt control. Because the quantity of speech messages and the quantity of non-speech messages are displayed separately, the terminal increases and decreases the quantities respectively.

3. First display the speech message playback control and then display the second message prompt control at the message prompt position corresponding to the target virtual figure, where duration of the first received speech message is displayed in the speech message playback control, and the quantity of unread non-speech messages is displayed in the second message prompt control.

In an implementation example, to simplify a virtual social scenario screen and reduce a quantity of displayed controls, when receiving a social message including a speech message, the terminal first displays the speech message playback control. When playback of a current speech message ends, there is no next speech message, and there is a non-speech message in the social message, the terminal updates the speech message playback control to the second message prompt control. The quantity of unread non-speech messages is displayed in the second message prompt control.

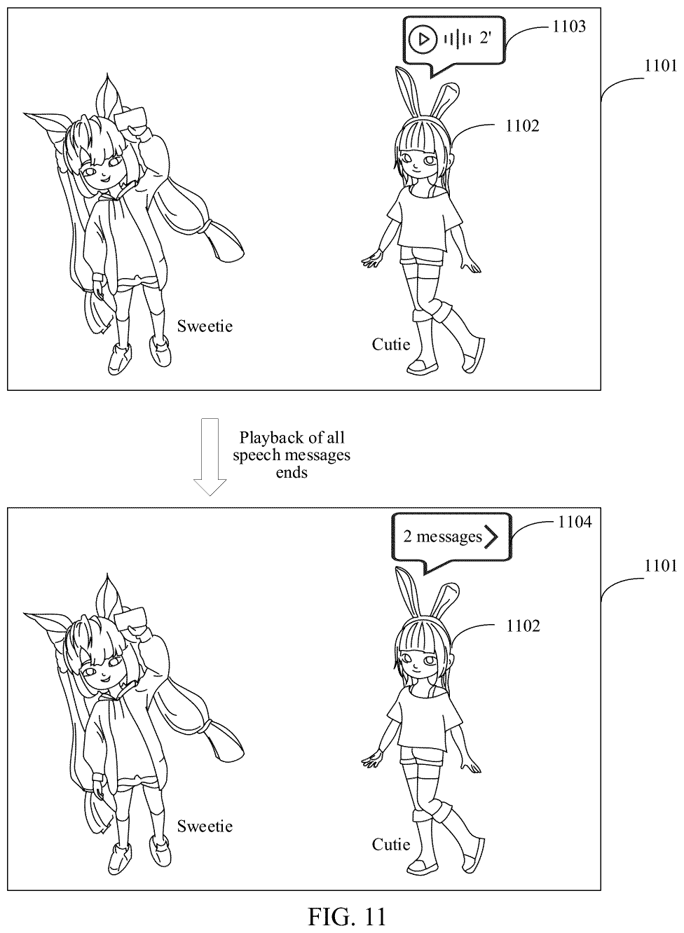

For example, as shown in FIG. 11, when a plurality of social messages are received, and the social messages include a plurality of speech messages and two non-speech messages, the terminal displays a speech message playback control 1103 at a message prompt position corresponding to a target virtual FIG. 1102 in a virtual social scenario 1101. Speech duration of the first received speech message is displayed in the speech message playback control 1103 (alternatively, only a quantity of unread speech messages is displayed while the speech duration is not displayed, or a quantity of unread speech messages and the speech duration are both displayed). The terminal plays back the received speech messages in response to a trigger operation on the speech message playback control 1103. When playback of all the speech messages ends, the terminal updates the speech message playback control 1103 to a second message prompt control 1104, and a quantity of unread non-speech messages displayed in the second message prompt control 1104 is two.

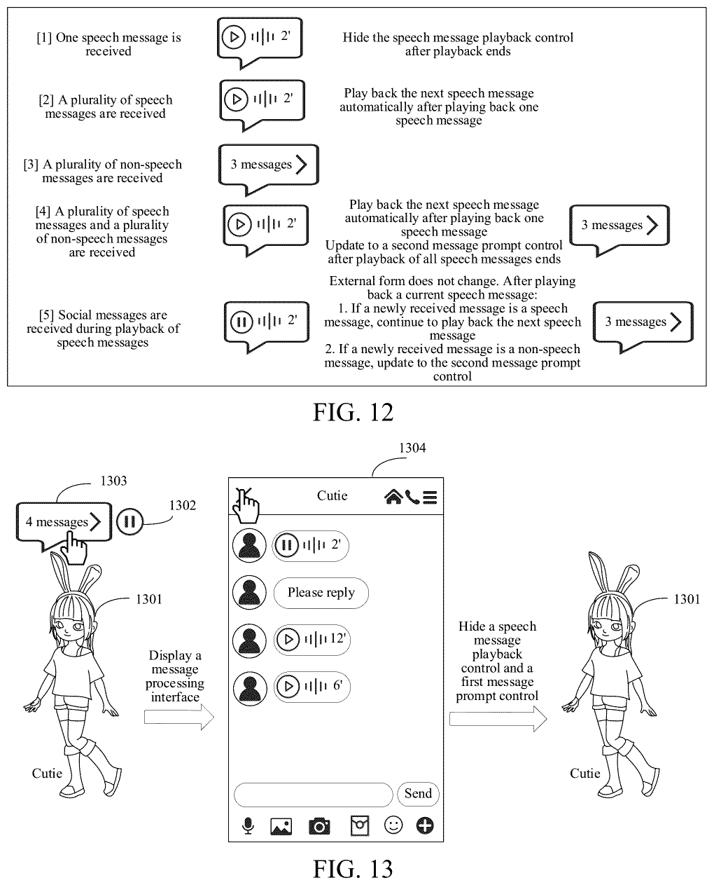

FIG. 12 is a schematic diagram of an implementation of control switching when different quantities of speech messages and non-speech messages are received according to an exemplary embodiment of this disclosure.

When receiving one speech message, the terminal displays the speech message playback control in the virtual social scenario. Speech duration of an unread speech message is displayed in the speech message playback control. The terminal plays back the speech message in response to the trigger operation on the speech message playback control. When playback of the speech message ends, the terminal hides the speech message playback control.

When receiving a plurality of speech messages, the terminal displays the speech message playback control in the virtual social scenario. Speech duration of the first speech message is displayed in the speech message playback control. The terminal plays back the speech messages in response to the trigger operation on the speech message playback control. After playing back the first speech message, the terminal automatically plays back the next speech message and displays speech duration of a current playback speech message in the speech message playback control.

When receiving a plurality of non-speech messages, the terminal displays the second message prompt control in the virtual social scenario, and the quantity of unread non-speech messages is displayed in the second message prompt control.

When receiving a plurality of non-speech messages and a plurality of speech messages, the terminal first displays the speech message playback control in the virtual social scenario. Speech duration of the first speech message is displayed in the speech message playback control. The terminal plays back the speech messages in response to the trigger operation on the speech message playback control. After playing back the first speech message, the terminal automatically plays back the next speech message and displays speech duration of a current playback speech message in the speech message playback control. After playing back all the speech messages, the terminal updates the speech message playback control to the second message prompt control.

During the playback of the speech message, when receiving a new speech message, the terminal keeps an external form of the current speech message playback control unchanged. After playing back all the previous speech messages, the terminal continues to play back the new speech message. After playing back all the speech messages, the terminal updates the speech message playback control to the second message prompt control.

During the playback of the speech message, when receiving a new non-speech message, the terminal keeps the external form of the current speech message playback control unchanged. After playing back all the speech messages, the terminal updates the speech message playback control to the second message prompt control. A quantity of all unread non-speech messages after a new non-speech message is received is displayed in the second message prompt control.

In the foregoing embodiment, the speech message playback control and the first message prompt control or the second message prompt control are set at the message prompt position corresponding to the target virtual figure, so that the quantity of unread speech messages and the quantity of unread non-speech messages included in the unread social messages can be displayed more clearly. In addition, the speech message playback control is updated to the second message prompt control, so that the control display in the virtual social scenario can be more concise, and a problem of accidental touch caused by simultaneous displaying a large quantity of controls in the virtual social scenario is avoided.

Because the received social messages may include a plurality of speech messages, to reflect logic between the speech messages, the terminal may play back, in response to the trigger operation on the speech message playback control, the received speech messages in sequence according to a reception sequence of the speech messages.

In one embodiment, when receiving a single trigger operation on the speech message playback control, the terminal may play back all unread speech messages in sequence. Alternatively, a single trigger operation on the speech message playback control is configured for triggering playback of one unread speech message. Correspondingly, a user may trigger the terminal to play a plurality of unread speech messages by triggering the speech message playback control a plurality of times.

In an implementation example, when there are at least two speech messages, the terminal obtains a time point when each speech message is received. According to a reception sequence of the at least two speech messages, the terminal plays back the speech messages in order from farthest to nearest in the virtual social scenario based on distances between time points of receiving the speech messages and a current time point.

To further improve convenience of obtaining a social message, when a received social message includes a speech message and a text message in a non-speech message, the terminal may convert the text message into a speech message by using a speech synthesis technology, to facilitate a user to directly receive a text message in the virtual social scenario. The following describes operations of the method in detail.

1. Convert, when there are at least two speech messages, and there is a text message between the at least two speech messages, the text message into a speech synthesis message.

In an implementation example, when a received social message includes at least two speech messages, and there is a text message between the at least two speech messages, if the terminal plays back the speech message separately, there may be a lack of coherence between the two speech messages. To view the text message between the two speech messages, a user needs to continue to enter the message processing interface.

In this embodiment of this disclosure, to receive a social message more conveniently in the virtual social scenario, when there is a text message between at least two speech messages (in other words, a transmitting time point of the text message is between transmitting time points of the at least two speech messages), the terminal converts the text message into a speech synthesis message.

In some embodiments, when a text message is not between speech messages, for example, the text message is before all speech messages, or the text message is after all speech messages, the terminal does not perform speech conversion on the text message.

In an implementation example, the terminal may locally perform the speech conversion on the text message by using a text to speech (TTS) technology to obtain a speech synthesis message. Alternatively, a server may perform speech conversion on the text message and transmit a converted speech synthesis message to the terminal. This is not limited in this embodiment.

Further, to improve the authenticity of the converted speech synthesis message, in an implementation example, the terminal or the server may train a model configured for text-to-speech conversion based on the speech message transmitted by the target social account, and use the trained text-to-speech conversion model to generate a speech synthesis message, so that the generated speech synthesis message matches timbre of a user corresponding to the target social account.

In the foregoing embodiment, an objective of performing the speech conversion on the text message is to improve contextual coherence during speech playback. However, in actual application, it is found that there may be no contextual relationship between continuously transmitted speech message and text message. To avoid converting a text message without a contextual relationship into a speech synthesis message, resulting in a waste of processing resources, in an implementation example, the terminal determines a message association degree between the text message and the at least two speech messages. When the message association degree is greater than an association degree threshold, the terminal converts the text message into the speech synthesis message. When the message association degree is less than the association degree threshold, the terminal directly plays back the speech messages in the virtual social scenario in sequence.

In an embodiment, the message association degree between the text message and the at least two speech messages may be determined according to reception time points of the messages of the terminal, or according to an association degree between content of the messages, or according to both the reception time points of the messages and the content of the messages. This is not limited in this embodiment of this disclosure.

In an implementation example, the terminal determines the message association degree and the association degree threshold according to the reception time points of the messages. First, the terminal determines a reception time interval between the text message and each speech message according to the reception time points of the text message and the at least two speech messages. Second, the terminal determines the message association degree between the text message and each speech message based on the reception time interval. The message association degree is in a negative correlative relationship with the reception time interval.

For example, the terminal determines the association degree threshold as a reception time interval of two messages of 1 minute. When two speech messages are received, and a text message is included between the two speech messages, the terminal determines reception time intervals between the text message and the two speech messages. When the reception time intervals are both less than 1 minute, the terminal converts the text message into a speech synthesis message. When one of the reception time intervals is greater than 1 minute, the terminal does not convert the text message.

In an implementation example, the terminal determines the message association degree and the association degree threshold according to each message content. First, the terminal determines to perform text conversion on the at least two speech messages to obtain a text conversion message. Second, the terminal determines a content correlation between the text message and the text conversion message, and determines the message association degree based on the content correlation. The message association degree is in a positive correlative relationship with the content correlation.

In one embodiment, the terminal may extract keywords in text to determine the message association degree based on an association degree between the keywords. Alternatively, the terminal may use a pre-trained enhanced sequential inference model (ESIM) or another natural language processing (NLP) model to determine the message association degree between the text messages. This is not limited in this embodiment.

Certainly, in another possible implementation, the foregoing operations of converting speech into text and determining the content correlation between text may be performed by the server, or by the terminal and the server in cooperation. This is not limited in this embodiment.

For example, the terminal determines the association degree threshold as the content correlation between messages that reaches 80%. When two speech messages are received, and a text message is included between the two speech messages, the terminal performs text conversion on the two speech messages to obtain text conversion messages, and determines content correlations between the text message and the text conversion messages. When the content correlations are both greater than 80%, the terminal converts the text message into a speech synthesis message. When one of the content correlations is less than 80%, the terminal does not convert the text message.

2. Display the speech messages and the speech synthesis message in sequence in the virtual social scenario according to a reception sequence of the at least two speech messages and the text message.

Further, according to the reception sequence of the at least two speech messages and the text message, the terminal plays back the speech messages and the speech synthesis message in a sequence from farthest to nearest in the virtual social scenario based on distances between time points of receiving the messages and a current time point.

In an implementation example, when playback of the speech synthesis message ends, the terminal does not update the quantity of unread speech messages displayed in the speech message playback control, but updates the quantity of unread social messages displayed in the first message prompt control, or updates the quantity of unread non-speech messages displayed in the second message prompt control.

In the foregoing embodiment, when the at least two speech messages are received, and there is the text message between the at least two speech messages, the terminal may appropriately perform the speech conversion on the text message based on the message association degree between the text message and the at least two speech messages, to directly play back the obtained speech synthesis message in the virtual social scenario. This not only improves semantic coherence of the speech played back in the virtual social scenario, but also further simplifies a message viewing operation and improves convenience of message viewing.

To facilitate a user to view and process a non-speech message, the terminal may set up a message processing interface in the virtual social scenario. The user can directly view and process a received non-speech message on the message processing interface. The following describes operations of the method in detail.

1. Obtain, when a message processing operation is received, and there is a target speech message being played, a speech playback progress of the target speech message.

In an implementation example, to maintain smoothness of speech message playback during message processing, the terminal obtains, when the message processing operation is received, and there is the target speech message being played back, the speech playback progress of the target speech message.

In one embodiment, the message processing operation may be the trigger operation on the first message prompt control or the trigger operation on the second message prompt control in the foregoing embodiment, or may be a trigger operation on the target virtual figure. This is not limited in this embodiment of this disclosure.

For example, as shown in FIG. 13, there are a speech message playback control 1302 and a first message prompt control 1303 at a message prompt position corresponding to a target virtual FIG. 1301. The speech message playback control 1302 is in a state of playing back a speech message, and a playback progress of a target speech message currently being played back is displayed. The terminal obtains the speech playback progress of the target speech message in response to a trigger operation on the first message prompt control 1303.

2. Display the message processing interface corresponding to the target social account, and continue to play back the target speech message on the message processing interface based on the speech playback progress.

Further, the terminal displays the message processing interface corresponding to the target social account, and continues to play back the target speech message on the message processing interface based on the obtained speech playback progress. This ensures continuity of the speech message playback during the display of the message processing interface.

For example, as shown in FIG. 13, the terminal displays a message processing interface 1304 corresponding to a target social account in response to the trigger operation on the first message prompt control 1303, and continues to play back the target speech message on the message processing interface 1304 based on the speech playback progress.

3. Hide the speech message playback control in response to a closing operation on the message processing interface.

In an implementation example, because all unread social messages are displayed when the message processing interface is displayed, after all received social messages are displayed on the message processing interface, the terminal hides the speech message playback control and the first message prompt control in response to the closing operation on the message processing interface.

For example, as shown in FIG. 13, the terminal hides the speech message playback control 1302 and the first message prompt control 1303 in response to a closing operation on the message processing interface 1304, and only displays the target virtual FIG. 1301.

In the foregoing embodiment, the terminal sets the message processing interface in the virtual social scenario. When the user views and processes the social message on the message processing interface, if there is the target speech message being played back, the terminal can obtain the speech playback progress of the target speech message. During the display of the message processing interface, the terminal plays back the target speech message smoothly. This ensures smoothness of the speech message playback.

To facilitate a user to continue to receive a speech message directly from a previously interrupted speech playback position after speech message playback is interrupted, the terminal sets a pause button and a playback button in the speech message playback control. By triggering the pause button or the playback button, the speech message may be played back continuously even if the speech message playback is interrupted. The following describes operations of the method.

1. Display a pause button in the speech message playback control in response to the trigger operation on the speech message playback control.

In an implementation example, the terminal plays back the speech message in response to the trigger operation on the speech message playback control, and displays the pause button in the speech message playback control. The pause button is configured for pausing the current playback speech message.

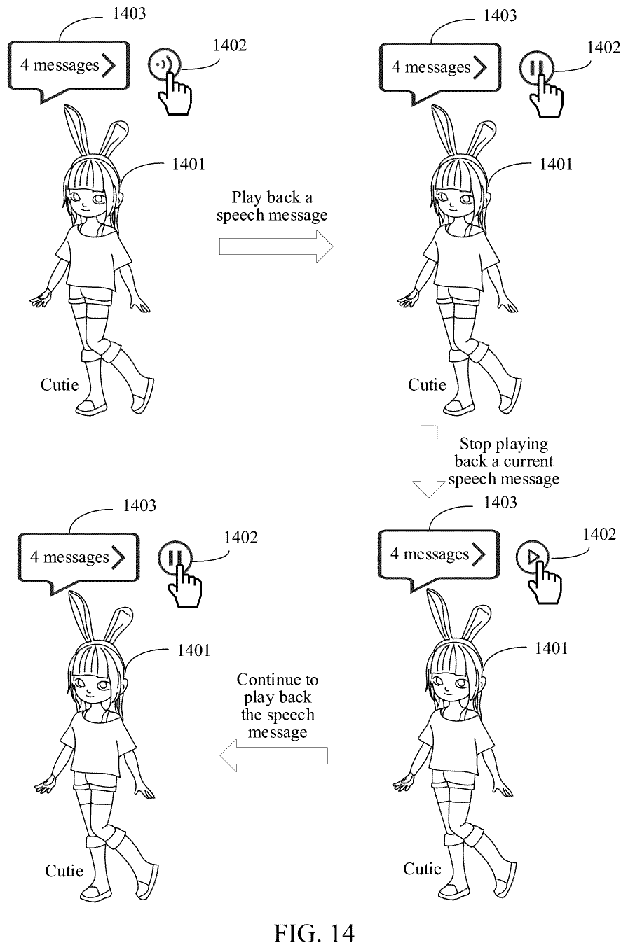

For example, as shown in FIG. 14, there are a speech message playback control 1402 and a first message prompt control 1403 at a message prompt position corresponding to a target virtual FIG. 1401. The terminal plays back the speech message in response to a trigger operation on the speech message playback control 1402, and displays a pause button in the speech message playback control 1402.

2. Update the pause button to a playback button in response to a trigger operation on the pause button, and stop playing back a current speech message.

In an implementation example, during the playback of the speech message, if the current playback speech message needs to be interrupted, the terminal updates the pause button to the playback button in response to the trigger operation on the pause button and stops playing back the current speech message. In addition, the terminal records a speech playback progress of the current speech message.

For example, as shown in FIG. 14, the terminal updates the pause button to a playback button in response to a trigger operation on the pause button in the speech message playback control 1402, and stops playing back the current speech message.

3. Update the playback button to the pause button in response to a trigger operation on the playback button, and continue to play back the speech message based on the recorded speech playback progress, the speech playback progress being recorded when the trigger operation on the pause button is received.

Further, to continue to play back the stopped speech message, the terminal continues to play back, in response to the trigger operation on the playback button, the speech message based on the recorded speech playback progress, and updates the playback button to the pause button.

For example, as shown in FIG. 14, the terminal continues to play back, in response to a trigger operation on the playback button in the speech message playback control 1402, the speech message based on the recorded speech playback progress, and updates the playback button in the speech message playback control 1402 to the pause button.

In the foregoing embodiment, the playback button and the pause button are set in the speech message playback control, so that the terminal can playback and stop playing back the speech message based on the trigger operations on different buttons of the user, and record the speech playback progress, to ensure continuity of the speech message playback.

In some embodiments, when duration of the speech message is greater than a duration threshold (such as 30s), the terminal may further display a progress adjustment control in the speech message playback control. The user can adjust the playback progress of the speech message by using the progress adjustment control. The progress adjustment control may be an audio progress bar.

In some other embodiments, the terminal may further display a playback speed adjustment control in the speech message playback control. The user can adjust playback speed of the speech message by using the playback speed adjustment control. For example, the playback speed adjustment control may be a variable speed playback control (0.5× speed, 1.5× speed, and the like).

In some other embodiments, when receiving a touch and hold operation on the speech message playback control, the terminal can accelerate the playback of the speech message according to preset playback speed, to improve listening efficiency of the speech message. For example, when receiving the touch and hold operation on the speech message playback control, the terminal plays back the speech message at 3× speed.

To simplify the social interaction between virtual figures in the virtual social scenario, the terminal may set a display condition of the speech message playback control, so that only speech messages transmitted by a part of accounts may be prompted with the control.

In an implementation example, the terminal determines whether there is a social relationship between social accounts. When a target social relationship is established between the target social account and the current account, the terminal displays the speech message playback control at the message prompt position corresponding to the target virtual figure in the virtual social scenario.

In one embodiment, the target social relationship may be a two-way following relationship between the accounts, or a one-way following relationship between the accounts. This is not limited in this embodiment of this disclosure.

There is the target social relationship between the accounts, which limits a quantity of virtual figures displayed in the virtual social scenario, simplifies the social interaction between the virtual figures in the virtual social scenario, and improves social effectiveness.

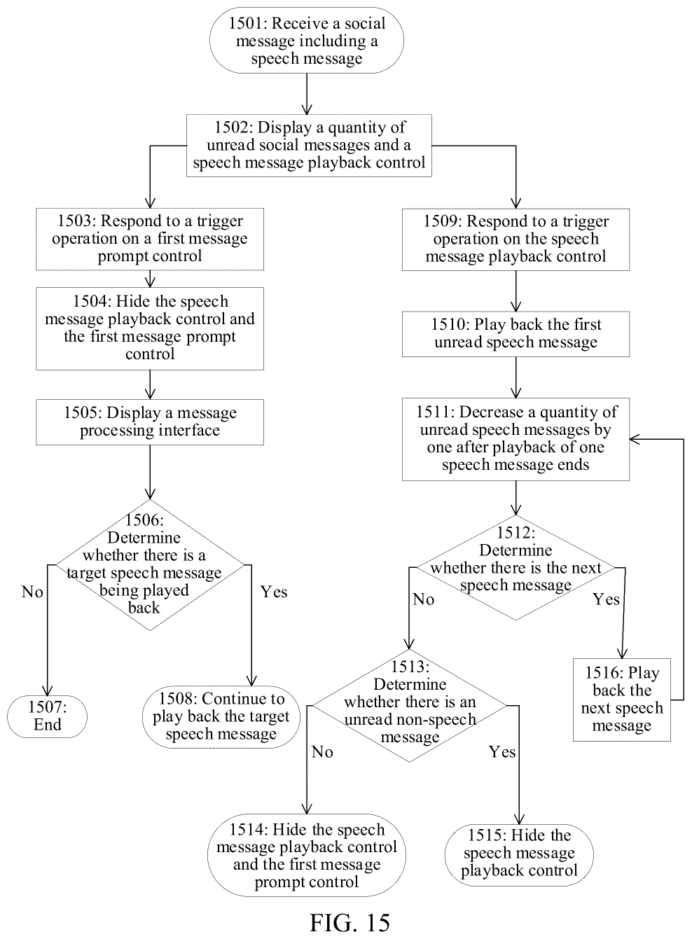

With reference to the foregoing embodiments, FIG. 15 is a flowchart of a speech message playback method according to an exemplary embodiment of this disclosure. The method includes the following operations:

Operation 1501: Receive a social message including a speech message.

A terminal receives a social message transmitted by a target social account, and the social message includes a speech message and a non-speech message.

Operation 1502: Display a quantity of unread social messages and a speech message playback control.

The terminal displays the speech message playback control and a first message prompt control at a message prompt position corresponding to a target virtual figure corresponding to the target social account. The quantity of unread social messages is displayed in the first message prompt control.

Operation 1503: Respond to a trigger operation on the first message prompt control.

The terminal responds to the trigger operation of a user on the first message prompt control.

Operation 1504: Hide the speech message playback control and the first message prompt control.

The terminal hides the speech message playback control and the first message prompt control in the virtual social scenario.

Operation 1505: Display a message processing interface.

The terminal displays the message processing interface in the virtual social scenario, and the user processes all received social messages on the message processing interface.

Operation 1506: Determine whether there is a target speech message being played back.

The terminal determines whether there is the target speech message being played back. If there is no target speech message, operation 1507 is performed. If there is the target speech message, operation 1508 is performed.

Operation 1507: End.

Operation 1508: Continue to play back the target speech message.

The terminal continues to play back the target speech message on the message processing interface, to ensure continuity of speech message playback.

Operation 1509: Respond to a trigger operation on the speech message playback control.

The terminal responds to the trigger operation of the user on the speech message playback control.

Operation 1510: Play back the first unread speech message.

Operation 1511: Decrease a quantity of unread speech messages by one when playback of one speech message ends.

After playback of one speech message ends, the terminal decreases the quantity of unread speech messages displayed in the speech message playback control by one and decreases the quantity of unread social messages displayed in the first message prompt control by one.

Operation 1512: Determine whether there is a next speech message.

The terminal determines whether there is the next speech message. If there is the next speech message, operation 1516 is performed. If there is no next speech message, operation 1513 is performed.

Operation 1513: Determine whether there is an unread non-speech message.

The terminal determines whether there is the unread non-speech message. If there is the unread non-speech message, operation 1515 is performed. If there is no unread non-speech message, operation 1514 is performed.

Operation 1514: Hide the speech message playback control and the first message prompt control.

If there is no unread non-speech message, after playback of all speech messages ends, the terminal hides the speech message playback control and the first message prompt control.

Operation 1515: Hide the speech message playback control.

If there is the unread non-speech message, after playback of all speech messages ends, the terminal hides the speech message playback control.

Operation 1516: Play back the next speech message.

If there is the next speech message, the terminal performs operation 1511, continues to play back the next speech message, and decreases the quantity of unread speech messages displayed in the speech message playback control by one.

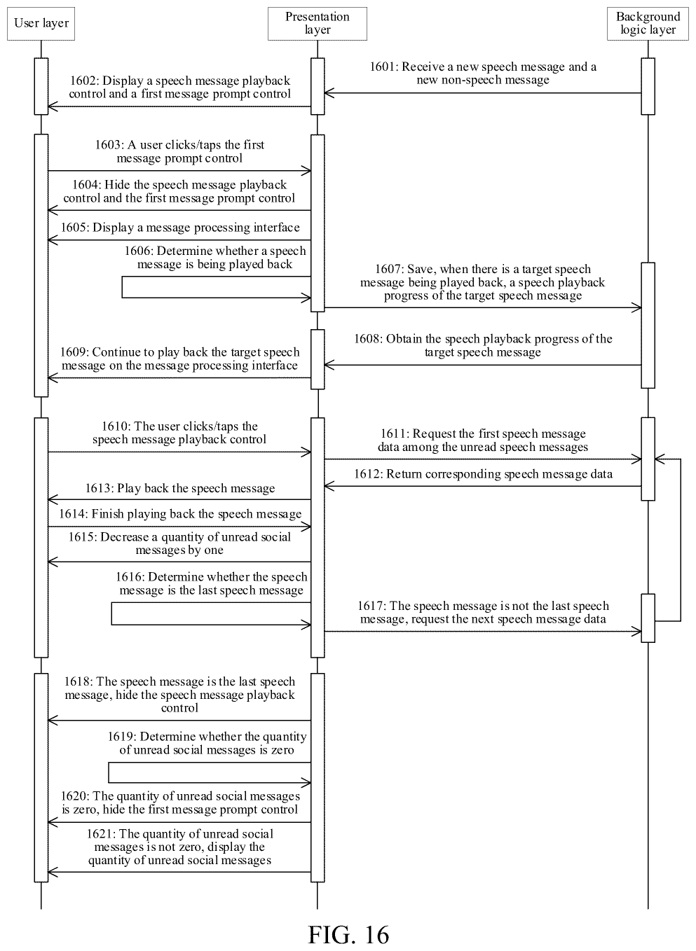

FIG. 16 is an interaction sequence diagram between a user layer, a presentation layer, and a background logic layer according to an exemplary embodiment of this disclosure. The interaction process may include the following operations:

Operation 1601: A terminal receives a new speech message and a new non-speech message from a background.

When a target social account transmits a social message to a current account, the terminal receives a new social message from the background, and the social message includes a speech message and a non-speech message.

Operation 1602: The terminal displays a speech message playback control and a first message prompt control to a user.

The terminal displays the speech message playback control and the first message prompt control based on a received unread social message. A quantity of unread social messages is displayed in the first message prompt control.

Operation 1603: The user clicks/taps the first message prompt control.

The terminal responds to the click/tap operation when the user clicks/taps the first message prompt control.

Operation 1604: The terminal hides the speech message playback control and the first message prompt control.

The terminal hides the speech message playback control and the first message prompt control in response to a trigger operation on the first message prompt control.

Operation 1605: The terminal displays a message processing interface.

The terminal displays the message processing interface and waits for the user to process the social message on the message processing interface.

Operation 1606: The terminal determines whether a speech message is being played back.

The terminal determines whether there is a speech message being played back. If there is a speech message being played back, operation 1607 is performed.

Operation 1607: Save, when there is a target speech message being played back, a speech playback progress of the target speech message in the background.

When there is the target speech message being played back, to ensure continuity of speech message playback, the speech playback progress of the target speech message is saved in the background.

Operation 1608: The terminal obtains the speech playback progress of the target speech message.

Further, the terminal obtains the speech playback progress of the target speech message from the background.

Operation 1609: The terminal continues to play back the target speech message on the message processing interface.

In this way, the terminal continues to play back the target speech message on the message processing interface.

Operation 1610: The user clicks/taps the speech message playback control.

The terminal responds to the click/tap operation when the user clicks/taps the speech message playback control.

Operation 1611: The terminal requests the first speech message data among the unread speech messages from the background.

To play back the speech message, the terminal requests the first speech message data among the unread speech messages from the background.

Operation 1612: The background returns corresponding speech message data to the terminal.

Operation 1613: The terminal plays back the speech message.

The terminal plays back the speech message based on the obtained speech message data.

Operation 1614: The terminal finishes playing back the speech message.

Operation 1615: The terminal decreases the quantity of unread social messages by one.

The terminal decreases the quantity of unread social messages displayed in the first message prompt control by one when playback of the speech message ends.

Operation 1616: The terminal determines whether the speech message is the last speech message.

The terminal determines whether a current playback speech message is the last speech message. If the current playback speech message is not the last speech message, operation 1617 is performed. If the current playback speech message is the last speech message, operation 1618 is performed.

Operation 1617: If the current playback speech message is not the last speech message, the terminal requests next speech message data from the background.

When the current playback speech message is not the last speech message, the terminal continues to request the next speech message data from the background, and operation 1611 is performed.

Operation 1618: If the current playback speech message is the last speech message, the terminal hides the speech message playback control.

When the current playback speech message is the last speech message, the terminal hides the speech message playback control.

Operation 1619: The terminal determines whether the quantity of unread social messages is zero.

The terminal determines whether the quantity of unread social messages is zero. If the quantity of unread social messages is zero, operation 1620 is performed. If the quantity of unread social messages is not zero, operation 1621 is performed.

Operation 1620: The quantity of unread social messages is zero, the terminal hides the first message prompt control.

When the quantity of unread social messages is zero, the terminal hides the first message prompt control at the message prompt position.

Operation 1621: The quantity of unread social messages is not zero, the terminal displays the quantity of unread social messages.

When the quantity of unread social messages is not zero, the terminal displays the quantity of unread social messages in the first message prompt control.

Information (including but not limited to user equipment information, users' personal information, and the like), data (including but not limited to data used for analysis, stored data, displayed data, and the like), and signals involved in this application are all authorized by the users or fully authorized by all parties, and collection, use, and processing of related data need to comply with relevant laws, regulations, and standards of relevant countries and regions. For example, the speech message, the non-speech message of the social account, and the like in this application are obtained under full authorization.

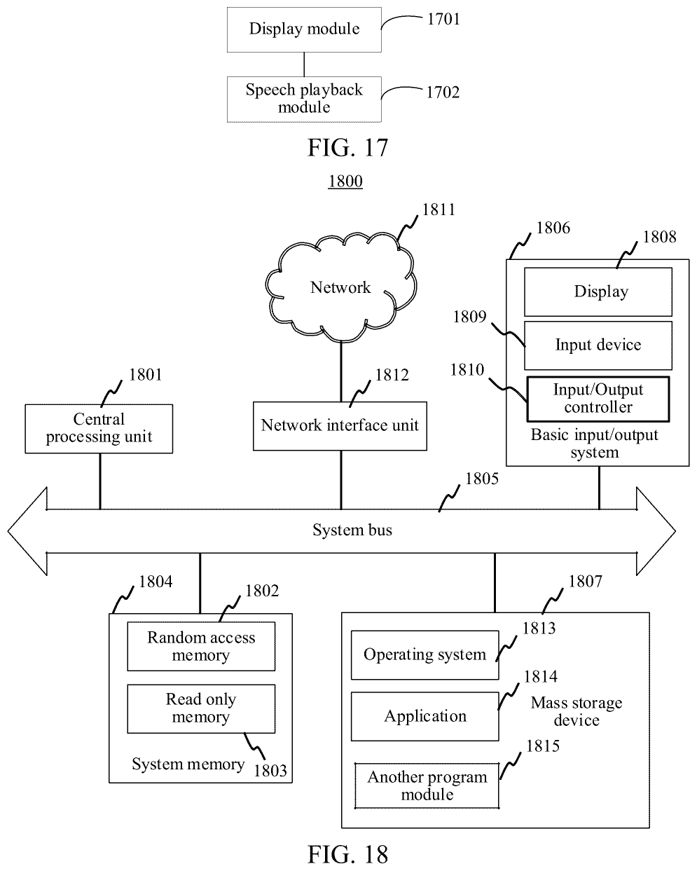

FIG. 17 is a block diagram of a structure of a speech message playback apparatus according to an exemplary embodiment of this disclosure. The apparatus may include the following structures:
a display module 1701, configured to display a virtual figure corresponding to at least one social account in a virtual social scenario, the virtual social scenario being a virtual scenario for the virtual figure to perform social interaction,
the display module 1701 being further configured to display, when a social message transmitted by a target social account is received, and the social message includes a speech message, a speech message playback control at a message prompt position corresponding to a target virtual figure in the virtual social scenario, the target virtual figure being a virtual figure corresponding to the target social account; and
a speech playback module 1702, configured to play back, in response to a trigger operation on the speech message playback control, the speech message in the virtual social scenario without displaying a message processing interface corresponding to the target social account.

In one embodiment, the speech playback module 1702 is configured to:
play back, when there are at least two speech messages, the speech messages in sequence in the virtual social scenario according to a reception sequence of the at least two speech messages.

In one embodiment, the speech playback module 1702 includes:
a speech synthesis unit, configured to convert, when there are at least two speech messages, and there is a text message between the at least two speech messages, the text message into a speech synthesis message; and
a speech playback unit, configured to play back the speech messages and the speech synthesis message in sequence in the virtual social scenario according to a reception sequence of the at least two speech messages and the text message.

In one embodiment, the speech synthesis unit is configured to:
determine a message association degree between the text message and the at least two speech messages; and
convert the text message into the speech synthesis message when the message association degree is greater than an association degree threshold.

The speech playback module 1702 is further configured to play back the speech messages in the virtual social scenario in sequence when the message association degree is less than the association degree threshold.

In one embodiment, the speech synthesis unit is configured to: determine a reception time interval according to reception time points of the text message and the at least two speech messages; determine the message association degree based on the reception time interval, the message association degree being in a negative correlative relationship with the reception time interval; and
perform text conversion on the at least two speech messages to obtain a text conversion message; determine content correlation between the text message and the text conversion message; and determine the message association degree based on the content correlation, the message association degree being in a positive correlative relationship with the content correlation.

In one embodiment, a quantity of unread speech messages is displayed in the speech message playback control.

The apparatus further includes:
a quantity recording module, configured to decrease the quantity of unread speech messages displayed in the speech message playback control by one when playback of a current speech message ends and there is a next speech message.

In one embodiment, a first message prompt control is also displayed at the message prompt position, a quantity of unread social messages is displayed in the first message prompt control, and the quantity of unread social messages is greater than or equal to the quantity of unread speech messages.

The quantity recording module is further configured to decrease the quantity of unread social messages displayed in the first message prompt control by one when the playback of the current speech message ends.

In one embodiment, a first message prompt control or a second message prompt control is also displayed at the message prompt position, a quantity of unread social messages is displayed in the first message prompt control, and a quantity of unread non-speech messages is displayed in the second message prompt control.

The apparatus further includes:
a control hiding module, configured to hide the speech message playback control when playback of a current speech message ends, and there is no next speech message.

In one embodiment, the apparatus further includes:
a control update module, configured to update the speech message playback control to a second message prompt control when playback of a current speech message ends, there is no next speech message, and there is a non-speech message in the social message, a quantity of unread non-speech messages being displayed in the second message prompt control.

In one embodiment, the apparatus further includes:
a progress obtaining module, configured to obtain, when a message processing operation is received, and there is a target speech message being played, a speech playback progress of the target speech message; and
an interface display module, configured to display the message processing interface corresponding to the target social account, and continue to play back the target speech message on the message processing interface based on the speech playback progress.

In one embodiment, the control hiding module is further configured to hide the speech message playback control in response to a closing operation on the message processing interface.

In one embodiment, the apparatus further includes:
a button display module, configured to display a pause button in the speech message playback control in response to the trigger operation on the speech message playback control; and
a button update module, configured to update the pause button to a playback button in response to a trigger operation on the pause button and stop playing back a current speech message.

The speech playback module 1702 is further configured to update the playback button to the pause button in response to a trigger operation on the playback button, and continue to playback the speech message based on a recorded speech playback progress, the speech playback progress being recorded when the trigger operation on the pause button is received.

In one embodiment, the display module 1701 is further configured to:
display, when a target social relationship is established between the target social account and a current account, the speech message playback control at the message prompt position corresponding to the target virtual figure in the virtual social scenario.

In the apparatus provided in the foregoing embodiments, the division of the foregoing functional modules is merely described as an example. In actual application, the foregoing functions may be assigned as needed to be implemented by different functional modules. In other words, an internal structure of the apparatus is divided into different functional modules, to implement all or part of the functions described above. In addition, the apparatus provided in the foregoing embodiments and the method embodiments are based on the same concept. For details of the implementation process, refer to the method embodiments. Details are not described herein again.

FIG. 18 is a schematic diagram of a structure of a terminal according to an exemplary embodiment of this disclosure. The terminal may be the server or the terminal in the foregoing embodiments. Specifically, the terminal 1800 includes a central processing unit (CPU) 1801, a system memory 1804 including a random access memory 1802 and a read-only memory 1803, and a system bus 1805 connecting the system memory 1804 and the central processing unit 1801. The terminal 1800 further includes a basic input/output system (I/O system) 1806 assisting in transmitting information between components in a computer, and a mass storage device 1807 configured to store an operating system 1813, an application 1814, and another program module 1815.

The basic input/output system 1806 includes a display 1808 configured to display information and an input device 1809 such as a mouse or a keyboard configured to input information by a user. The display 1808 and the input device 1809 are both connected to the central processing unit 1801 by using an input/output controller 1810 connected to the system bus 1805. The basic input/output system 1806 may further include the input/output controller 1810 to be configured to receive and process input from a plurality of other devices such as a keyboard, a mouse, and an electronic stylus. Similarly, the input/output controller 1810 further provides an output to a display screen, a printer, or another type of output device.

The mass storage device 1807 is connected to the central processing unit 1801 by using a mass storage controller (not shown) connected to the system bus 1805. The mass storage device 1807 and a computer-readable medium associated with the mass storage device provide non-volatile storage to the terminal 1800. To be specific, the mass storage device 1807 may include a computer-readable medium (not shown) such as a hard disk or a drive.

In general, the computer-readable medium may include a computer storage medium and a communication medium. The computer storage medium includes volatile and non-volatile media, and removable and non-removable media implemented by using any method or technology configured for storing information such as computer-readable instructions, data structures, program modules, or other data. The computer storage medium includes a random access memory (RAM), a read only memory (ROM), a flash memory or another solid-state storage technology, a compact disc read-only memory (CD-ROM), a digital versatile disc (DVD) or another optical storage, tape cassette, magnetic tape, disk storage, or another magnetic storage device. It is noted that the computer storage medium is not limited to the foregoing several types. The system memory 1804 and the mass storage device 1807 may be collectively referred to as a memory.

The memory has one or more programs stored therein. The one or more programs are configured to be executed by one or more central processing units 1801. The one or more programs include instructions for implementing the foregoing method. The central processing unit 1801 executes the one or more programs to implement the method provided in the foregoing method embodiments.

According to embodiments of this disclosure, the terminal 1800 may alternatively be connected, over a network such as the Internet, to a remote computer on the network to run. To be specific, the terminal 1800 may be connected to a network 1812 by using a network interface unit 1811 connected to the system bus 1805, or may be connected to another type of network or a remote computer system (not shown) by using the network interface unit 1811.

An embodiment of this disclosure further provides a non-transitory computer-readable storage medium. The readable storage medium has at least one instruction stored thereon. The at least one instruction is loaded and executed by a processor to implement the speech message playback method provided in the foregoing embodiments.

An embodiment of this disclosure provides a computer program product or a computer program. The computer program product or the computer program includes computer instructions stored on a computer-readable storage medium. A processor of a computer device reads the computer instructions from the computer-readable storage medium. The processor executes the computer instructions, to cause the computer device to perform the speech message playback method provided in the foregoing embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are some embodiments of this disclosure, but are not intended to limit this disclosure. Any modification, equivalent replacement, or improvement made within the spirit and principle of this disclosure fall within the protection scope of this disclosure.

What is claimed is:

1. A method for speech message playback, comprising:
displaying a virtual social scenario including a first virtual figure associated with a first social account, the first social account of the first virtual figure performing social interaction with at least another social account in the virtual social scenario;
displaying, when one or more social messages transmitted by a second social account are received and the one or more social messages comprise a speech message, a speech message playback control at a message prompt position of a second virtual figure associated with the second social account in the virtual social scenario; and
playing back, in response to a first trigger operation on the speech message playback control, the speech message in the virtual social scenario without involving a message processing interface listing the one or more social messages received from the second social account.

2. The method according to claim 1, wherein the playing back comprises:
playing back, when the one or more social messages include a plurality of speech messages, the plurality of speech messages in the virtual social scenario according to a reception sequence of the plurality of speech messages.

3. The method according to claim 2, wherein the playing back comprises:
converting, when the one or more social messages include a text message between two speech messages in the plurality of speech messages, the text message into a speech synthesis message; and
playing back the speech synthesis message between the two speech messages.

4. The method according to claim 3, further comprising:
determining a message association degree between the text message and the two speech messages; and
converting the text message into the speech synthesis message when the message association degree is greater than an association degree threshold.

5. The method according to claim 3, further comprising:
determining a message association degree between the text message and the two speech messages; and
playing back the two speech messages in sequence when the message association degree is less than an association degree threshold.

6. The method according to claim 4, wherein the determining the message association degree comprises:
determining one or more reception time intervals of the text message to the two speech messages; and
determining the message association degree based on the one or more reception time intervals, the message association degree being in a negative correlative relationship with the one or more reception time intervals.

7. The method according to claim 4, wherein the determining the message association degree comprises:
performing a text conversion on at least one of the two speech messages to obtain a text conversion message;
determining a content correlation between the text message and the text conversion message; and
determining the message association degree based on the content correlation, the message association degree being in a positive correlative relationship with the content correlation.

8. The method according to claim 1, wherein the one or more social messages comprises at least one speech message, a quantity of unread speech messages in the at least one speech messages is displayed with the speech message playback control, the method further comprises:
decreasing the quantity of unread speech messages displayed with the speech message playback control by one when a playback of a current speech message ends and a next speech message exists in the at least one speech messages.

9. The method according to claim 8, wherein a first message prompt control is displayed at the message prompt position, a quantity of unread social messages in the one or more social messages is displayed with the first message prompt control, and the quantity of unread social messages is greater than or equal to the quantity of unread speech messages, the method further comprises:
decreasing the quantity of unread social messages displayed with the first message prompt control by one when the playback of the current speech message ends.

10. The method according to claim 1, further comprising:
hiding the speech message playback control when the one or more social messages have no more unread speech messages that have not been played back.

11. The method according to claim 1, further comprising:
changing the speech message playback control to a message prompt control with a quantity of unread non-speech messages in the one or more social messages when the one or more social messages have no more unread speed messages that have not been played back.

12. The method according to claim 1, further comprising:
obtaining, when a message processing operation is received and a current speech message being played, a speech playback progress of the current speech message;
displaying the message processing interface for the second social account; and
continuing to play back the current speech message in the message processing interface based on the speech playback progress of the current speech message.

13. The method according to claim 12, further comprising:
hiding the speech message playback control when the message processing interface is closed.

14. The method according to claim 1, further comprising:
displaying a pause button in the speech message playback control in response to the first trigger operation on the speech message playback control;
updating the pause button to a playback button in response to a second trigger operation on the pause button that pauses the playing back of the speech message; and
updating the playback button to the pause button in response to a third trigger operation on the playback button that continues the playing back of the speech message based on a recorded speech playback progress in response to the second trigger operation on the pause button.

15. The method according to claim 1, wherein the displaying the speech message playback control comprises:
displaying, when a social relationship is established between the second social account and the first social account, the speech message playback control at the message prompt position of the second virtual figure in the virtual social scenario.

16. An apparatus, comprising processing circuitry configured to:
display a virtual social scenario including a first virtual figure associated with a first social account, the first social account of the first virtual figure performing social interaction with at least another social account in the virtual social scenario;
display, when one or more social messages transmitted by a second social account are received and the one or more social messages comprise a speech message, a speech message playback control at a message prompt position of a second virtual figure associated with the second social account in the virtual social scenario; and
play back, in response to a first trigger operation on the speech message playback control, the speech message in the virtual social scenario without involving a message processing interface listing the one or more social messages received from the second social account.

17. The apparatus according to claim 16, wherein the processing circuitry is configured to:
play back, when the one or more social messages include a plurality of speech messages, the plurality of speech messages in the virtual social scenario according to a reception sequence of the plurality of speech messages.

18. The apparatus according to claim 17, wherein the processing circuitry is configured to:
convert, when the one or more social messages include a text message between two speech messages in the plurality of speech messages, the text message into a speech synthesis message; and
play back the speech synthesis message between the two speech messages.

19. The apparatus according to claim 18, wherein the processing circuitry is configured to:
determine a message association degree between the text message and the two speech messages; and
convert the text message into the speech synthesis message when the message association degree is greater than an association degree threshold.

20. A non-transitory computer-readable storage medium storing instructions which when executed by at least one processor cause the at least one processor to perform:
displaying a virtual social scenario including a first virtual figure associated with a first social account, the first social account of the first virtual figure performing social interaction with at least another social account in the virtual social scenario;
displaying, when one or more social messages transmitted by a second social account are received and the one or more social messages comprise a speech message, a speech message playback control at a message prompt position of a second virtual figure associated with the second social account in the virtual social scenario; and
playing back, in response to a first trigger operation on the speech message playback control, the speech message in the virtual social scenario without involving a message processing interface listing the one or more social messages received from the second social account.
